(19) United States
(12) Patent Application Publication
(10) Pub. No.: US 2020/0024945 A1
(43) Pub. Date: Jan. 23, 2020

(54) OPPOSED PISTON COMBUSTION ENGINE USING CRANK AND CAM

(71) Applicant: John Hartman, CUYAHOGA FALLS, OH (US)

(72) Inventor: John Hartman, CUYAHOGA FALLS, OH (US)

(21) Appl. No.: 16/458,025

(22) Filed: Jun. 29, 2019

Related U.S. Application Data
(60) Provisional application No. 62/701,810, filed on Jul. 22, 2018.

(51) Int. Cl. F01B 7/14; F01B 9/06; F01B 9/02

(52) U.S. Cl. CPC F01B 7/14; F01B 9/06; F02B 75/28; F01B 2009/061; F01B 9/02

(57) ABSTRACT

An opposed piston combustion engine is revealed that uses a crank to actuate one piston while using a cam to actuate a second piston within a shared cylinder. This engine allows crank leverage, compression, and ignition to occur closer together for a more efficient opposed piston engine.

### CROSS-REFERENCE TO RELATED APPLICATIONS

This application claims the benefit of provisional patent application No. 62/701,810, filed 22 Jul. 2018 by the present inventor, which is incorporated by reference in its entirety.

### STATEMENT REGARDING FEDERALLY SPONSORED RESEARCH OR DEVELOPMENT (IF APPLICABLE)

Not applicable

### REFERENCE TO SEQUENCE LISTING, A TABLE, OR A COMPUTER PROGRAM LISTING COMPACT DISC APPENDIX (IF APPLICABLE)

Not applicable

### BACKGROUND OF THE INVENTION

### Opposed Piston Engine

The present invention relates to opposed piston combustion engines, particularly to opposing pistons that share a single uniform cylinder and/or use a crank and a cam to actuate the respective pistons.

Opposed piston internal combustion engines use two pistons to manage the compression and combustive expansion of gas between them within a cylinder. This opposing piston configuration is considered by some to be a more efficient technique of managing combustion. The history of opposed piston engines and the varied approaches to making them work is rich.

### The Conventional Crank

The expansion of gasses in combustion is the target of any engine designed to produce work, and many combustion engines utilize a crank to convert the linear aspect of piston motion into rotational motion that can turn gears or shafts. The crank is a solid object with offset centerlines, so the motion of a piston actuated by a conventional crank will never be anything but a sine wave on a chart, and there is no flexibility in its function.

The arm of a crank is a lever. A lever works best when the force and lever are orthogonal, which means that the arm of the crank and the connecting rod should be in a region near 90 degrees for more efficient force transmission. But, the better place for combustion is where the compression of the gases is near a relative maximum. In most conventional engines, this occurs when the arm of the crank and the connecting rod are aligned and fully extended into the cylinder, also known as Top Dead Center (TDC). Force from combustion that occurs at TDC is a waste of energy, because it does not result in rotation of the crank until the crank is somehow rotated past TDC where the combustive force can be utilized. Most engine makers accept this displaced relationship between a relative maximum compression and a relative maximum leverage and make concessions. Many engines have spark ignition systems that ignite the fuel closer to the better leverage of the crank, but then they remain further from the better compression potential. Diesel engines use compression to ignite the fuel, but without rotational inertia, combustion can completely occur at TDC which does nothing to turn the crank. A diesel engine can also begin to run backward by igniting the fuel before TDC.

Stroke is a word used to describe the linear motions of a piston created by the crank. A 2-stroke engine means that the piston moves outward for one stroke and moves inward for the second stroke. Fuel ignition occurs with every second stroke. A 4-stroke engine means that fuel ignition occurs in every fourth stroke. The extra strokes serve to aspirate the gases in the cylinder usually by the use of a valve system.

### Two Crank Actuated Pistons

There are many examples of opposed piston engines using crank actuation that include U.S. Pat. No. 3,485,221 to Feeback (1969). Opposed piston engines that use crank motion to manage the choreography between the two pistons are still limited by the same separation compromise between compression and leverage in the use of cranks. FIG. 8 is prior art and illustrates an offset sine wave between two pistons that prior art opposed piston engines use. The engine's compression peak is located between the two points of TDC for the upper and lower piston. The peak is located far in advance of the efficiency range. Another drawback is the rate of retraction between the pistons using two cranks. Pistons that follow two sine waves that perfectly mirror each other (not shown) will retract from each other at double the rate of a single crank which means that combustion expansion must compete with this doubled inherent rate within the mechanism of the engine.

### Two Cam Actuated Pistons

There are many examples of the use of cams to actuate both pistons in opposed piston engines. Cams are capable of a much more creative choreography between pistons. U.S. Pat. No. 4,996,953 to Buck (1991) uses two cams, but it is believed that cams are better suited for creating linear motions than receiving them. The goal of efficiency in any internal combustion engine is to more efficiently harness work from combustion, so receiving linear motion with a cam may be less efficient.

### Crank Piston and Cam Piston

The U.S. Pat. No. 2,420,779 to Holmes (1947) discloses an opposed piston engine that uses a crank to actuate one piston while using a cam to actuate the other piston. However, this engine uses two different sized pistons inside two different sized cylinders, so the two pistons cannot overlap paths very well. While this may allow the peak of compression to occur later in the crank rotation, it will limit the amount of compression that can be obtained between the two pistons.

### BRIEF SUMMARY OF THE INVENTION

An ideal combustion engine might have the relative maximum compression and combustion occur at the same time while being closer to the relative maximum leverage of a crank arm. This would increase efficiency by increasing the work drawn from a given amount of fuel. The following embodiments provide the necessary choreography to make this possible.

In accordance with one embodiment, an opposed piston internal combustion engine is revealed that uses two pistons of similar size that share a single cylinder with a uniform bore while one piston is actuated by a crank and the other piston is actuated by a cam. This crank-and-cam relationship combines the efficient leverage of a crank with the choreography of a cam which is able to relocate the greater compression potential of a piston cycle closer to the better leverage potential of the crank arm for combustion efficiency.

FIG. 2 illustrates the advantage of these embodiments over the prior art. It shows a typical crank actuated piston path with a TDC. It shows that the addition of an opposing piston that is actuated by a cam suddenly makes this engine produce compression after the crank TDC and at the beginning of a better leverage advantage upon the crank arm. After ignition, the cam piston can remain motionless in this advantaged position with little effort throughout the fuel burn (the horizontal line section of the cam piston between the crank peaks). An engine builder can also choreograph small cam piston motions to tailor an aspiration need by the shape of the cam lobe.

### BRIEF DESCRIPTION OF THE SEVERAL VIEWS OF THE DRAWING

FIGS. 1A-1E, each show an orthogonal side view. Each view is a sequential crank and cam time step of a single crank revolution in accordance with the first embodiment.

FIG. 2 is a graph that represents the steps shown in FIGS. 1A-1E in accordance with the first embodiment. The distance between the pistons and the position of each piston within the cylinder are plotted according to time. The y-axis number values are relative between the upper and lower sections of the chart, otherwise they are arbitrary.

FIG. 2A shows the cam profile responsible for the data in FIG. 2.

FIG. 2B shows a close up view of the compression section of FIG. 2.

FIG. 3 is a perspective view of the first embodiment.

FIG. 4 is a top view of a second embodiment that is a 4-cylinder bank of the first embodiment.

FIG. 5 shows a graph that reflects data using a different cam turning at a 2:1 ratio over the crank. The distance between the pistons and the position of each piston within the cylinder are plotted according to time. The y-axis number values are relative between the upper and lower sections of the chart, otherwise they are arbitrary.

FIG. 5A shows the cam profile responsible for the data in FIG. 5.

FIG. 5B shows an orthogonal side view.

FIG. 6 shows another embodiment with pins and camshaft rearranged.

FIG. 7 shows an orthogonal side view of another embodiment without a strut.

FIG. 7A shows a perspective view of parts in FIG. 7.

FIG. 8 is prior art. It is a graph of data representing prior art that uses a crank to actuate each piston. The distance between the pistons and the position of each piston within the cylinder are plotted according time.

### DETAILED DESCRIPTION OF THE INVENTION

### First Embodiment

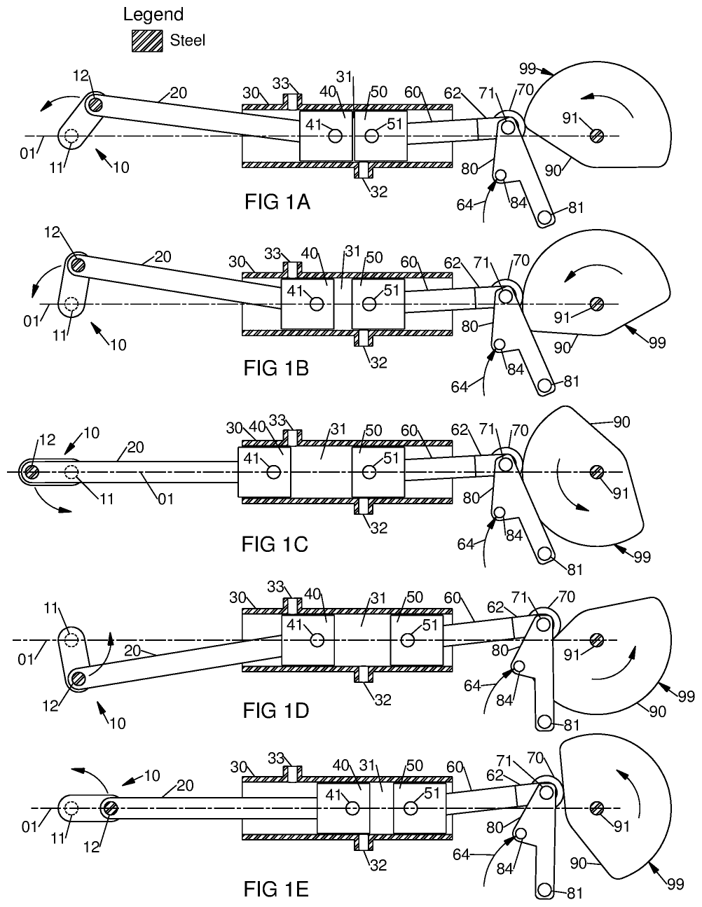

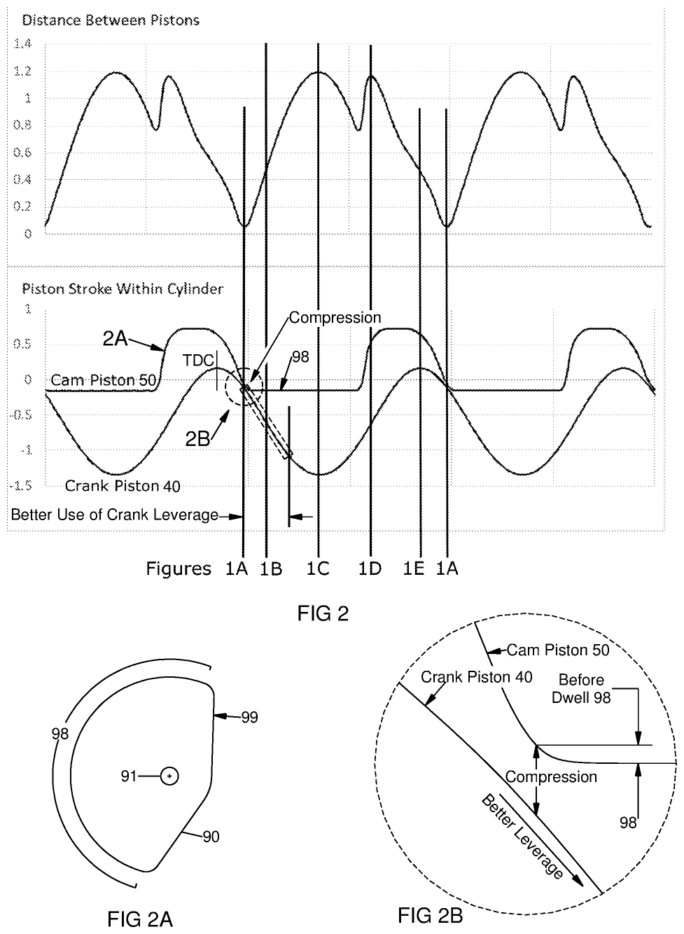

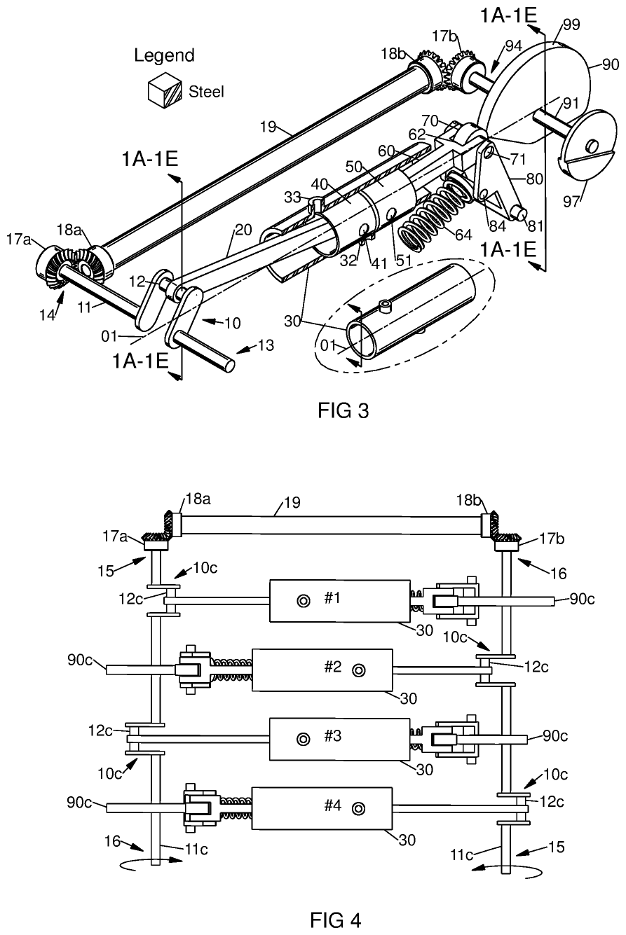

FIGS. 1A-1E, 2, 2A, 2B, and 3 show the first embodiment. FIG. 3 is a perspective view of this embodiment with much of the engine omitted for clarity and relevance. The drawings are provided to support limited concepts in the descriptions of making and using, so they are not for scale or construction. All parts are known to one skilled in the art of engine building. Many needed systems were omitted as being known in the art and less pertinent, including but not limited to, lubrication, cooling, electrical, and specific systems of aspiration.

FIGS. 1A-1E show a cylinder 30 that has a uniform inner bore diameter throughout, made of steel, and has a centerline 01. Cylinder 30 is rigidly fixed within a crankcase made of cast aluminum (not shown). Cylinder 30 is illustrated with an intake 32 and an exhaust 33. Aspirating a cylinder is known to one skilled in the art of engine building, but the illustrated embodiment lends itself to a 2-stroke diesel or a 2-stroke compression ignited gasoline engine. Aspiration depends upon an engine builder's need or preference. Cylinder 30 slidably and concentrically hosts a crank piston 40 and a cam piston 50 and each contain the pertinent hardware for combustion engines such as rings (not shown). Each piston is made of an aluminum alloy. Each piston 40 and 50 has a combustion end (not labeled). The combustion ends of each piston, 40 and 50, face each other to create a volume within the cylinder labeled as a combustion chamber 31. The crank piston 40 is pivotally connected to a right end (not labelled) of an aluminum crank rod 20 by a steel crank pin 41. Cam piston 50 is pivotally connected to a left end (not labelled) of an aluminum cam rod 60 by a steel cam pin 51. Cam rod 60 extends beyond a right side (not labelled) of cylinder 30. Crank rod 20 extends beyond a left side (not labelled) of cylinder 30 and pivotally connects to an eccentric shaft, eccentric 12 (also shown in FIG. 3).

In FIG. 3, eccentric 12 serves as an offset shaft of a crankshaft 11. The offset creates a crank 10. Eccentric 12 and crank 10 are a U-shaped feature of crankshaft 11. Crankshaft 11, eccentric 12, and crank 10 compose a set of features fashioned into a single steel part known in the art as a crank. Crankshaft 11 is rotationally balanced around a rotational connection to the crankcase (not shown). As crankshaft 11 rotates, crank 10 creates a maximum extension for piston 40 into cylinder 30 called a Top Dead Center, or TDC (labelled in FIG. 2 and the physical condition in FIG. 1E). Crankshaft 11 rotates perpendicular to centerline 01. Crankshaft 11 has a utility end 14 for engine functions and an output end 13 for engine work output.

In FIG. 3, the utility end 14 of crankshaft 11 is coupled to rotate at a 1:1 ratio with a utility end 94 of a camshaft 91. Camshaft 91 is located on an opposite side of cylinder 30 as crankshaft 11 and rotates parallel to crankshaft 11. This embodiment has crankshaft 11 and camshaft 91 turn in the same direction solely to allow power transmission options such as chain and sprockets. This embodiment has a power transmission set that consists of two right-hand-spiral bevel gears, 17a and 17b, and two left-hand-spiral bevel gears, 18a and 18b. The gears are made of steel. The gears mesh teeth and are paired 17a with 18a and 17b with 18b. A driveshaft 19, made of steel, rigidly connects gears 18a and 18b in a balanced rotation and is rotationally connected to the crankcase (not shown). Gears 17a and 17b are facing in opposing directions axially on their shafts so they will each rotate shafts in the same direction, but they can face in the same direction to cause the shafts to turn in opposing directions for preference. To allow this option, eccentric 12 must be placed in a mirrored position relative to centerline 01 (not shown). All gears are slidably fit and keyed to couple rotation with their respective shaft. The set is constructed to transmit rotational force from the utility end 14 of crankshaft 11 to the utility end 94 of camshaft 91. Power transmission is known to those skilled in the art of engine building.

In FIG. 3, camshaft 91 is a machined steel unitary part with other features such as a cam 90 and a flywheel 97. Camshaft 91 is rotationally connected to the crankcase (not shown). The cam 90 is known in the art as a cam lobe. The cam 90 has an outer radial surface 99 that has a non-circular profile about the cam 90 circumference to provide a variable radius with the rotation of camshaft 91. Surface 99 has a section of relatively consistent radius, dwell 98, shown in FIG. 2A. The specific profile of surface 99 is not implied by the drawings. It is important for piston 50 to intercept piston 40 to create compression, so the surface 99 is fashioned, at least, for that purpose. Other surface profiles suffice. Flywheel 97 is located adjacent to cam 90 or is part of cam 90 and constructed to serve as a counterbalance for cam 90. In this embodiment, flywheel 97 may be constructed of sufficient mass to serve as rotational momentum.

In FIG. 3, a camroller 70 is a steel cylindrical wheel aligned parallel to roll along the surface 99 of cam 90. Camroller 70 is rotationally connected to a roller pin 71 which is made of steel. Roller pin 71 is rigidly fit into two bifurcated arms (not labelled) of a strut 80 bridging a gap between the arms. Camroller 70 is centered in the gap on pin 71. Strut 80 is made of steel and has a bifurcated side and a crankcase side. The crankcase side is pivotally connected to the crankcase (not shown) by a steel strut pin 81. Strut 80 has a substantial length that places pin 71 slightly beyond centerline 01 relative to pin 81 and camshaft 91 (as in FIG. 1D or similar). At its midsection between the arms, Strut 80 has a crossmember 84 rotationally connected to each arm bridging the gap between the arms that is constructed to host a compression spring 64 and the associated force from spring 64. Strut 80 is constructed to maintain a non-contact clearance between cam 90 and crossmember 84.

Spring 64 is a steel compression spring that imparts an expansive force between the crankcase (not shown) and the strut 80. This expansive force results in sufficient contact between roller 70 and surface 99 throughout the rotation of cam 90.

In FIG. 3, camrod 60 has a bifurcated end 62 that straddles without touching camroller 70 and is rotationally connected to roller pin 71 within the gap between the arms of strut 80.

### Operation

FIGS. 1A-1E illustrate the operation of a first embodiment in five sequential time steps of a single revolution of crankshaft 11. The time steps are also shown in FIG. 2 as vertical lines labelled 1A, 1B, 1C, 1D, and 1E together with the positions of both pistons to illustrate the advantages of this crank-and-cam relationship.

FIGS. 1A-1E, this embodiment has cam piston 50 move rapidly toward crank piston 40 to squeeze an air-fuel mixture to the point of ignition (FIG. 1A). This fuel compression and ignition occur at a better leverage advantage between crank 10 and rod 20. The specific point of ignition relative to the angular position of crank 10 is adjustable by making small changes to the location and timing of cam 90.

FIG. 2B is a blown up view of the compression event in the chart of FIG. 2. After a compression potential is reached between pistons 40 and 50, FIGS. 2 and 2A, the dwell 98 essentially locks the cam piston 50 into position against the combustion force throughout the fuel burn, shown by the cam piston line remaining horizontal on the chart. The physical condition of dwell 98 is represented by FIGS. 1B and 1C. Post ignition, FIG. 1C, piston 40 uncovers exhaust 33 exposing it to chamber 31 to release the exhaust from its own pressure. At FIG. 1D, the intake 32 is uncovered by piston 50, and intake is drawn by vacuum pressure. Intake 32 can be controlled by any intake technique known to the art of engine building.

FIG. 2 shows that compression is not created by a crank's TDC as it is in other engines. Compression is created after the TDC of piston 40, and this compression potential is located at the beginning of the better leverage advantage of crank 10.

FIG. 2B shows a Distance to Dwell 98. It is believed that compression ignition of fuel using cam 90 may experience resistance prior to dwell 98. This is the source of the need for rotational inertia in camshaft 91 provided by flywheel 97. In addition to being a counterbalance, flywheel 97 can provide rotational inertia to help carry the cam 90 through the force of compression ignition by getting roller 70 to dwell 98, especially if gasoline is used and compressed to ignition.

In FIGS. 1A-1E, the geometrical placement of pins 71, 81, and camshaft 91 is intended to reduce the force needed during the compression stroke of piston 50 while increasing its rate of retraction. This can be seen in FIG. 2 as the slope of the line in retraction is steeper than the slope of the line to compression. Other geometrical placements will suffice according to an engine builder's need.

In FIG. 2, the vertical line in the chart that represents the time step 1D illustrates another step toward efficiency with this embodiment. Spring 64 was compressed and held by the dwell 98 of cam 90 prior to this condition at 1D. The cam 90 allows the spring force to cause the retraction of piston 50, and it does so at the leverage advantage of crank 10 on the return stoke of piston 40. This could cause a low pressure condition between the pistons 40 and 50 allowing some energy from spring 64 to be recaptured by the engine prior to piston 50 reaching intake 32 and aspirating the cylinder 30.

This embodiment reflects a 2-stroke diesel type of engine, because it is structurally simpler. Best mode is declared here for simplicity, but an engine builder may have a need that might require a more complicated engine using valves and forced induction systems.

### Second Embodiment

FIG. 4 shows how the first embodiment can be configured as a bank of cylinders. The second embodiment is multiple iterations of the first embodiment aligned parallel and oriented 180 degrees with each adjacent iteration. Other facilitating changes are described.

In FIG. 4, gear 17a is reversed to face the same as gear 17b. This causes the respective shafts to turn in opposite directions.

In FIG. 4, two mainshafts 11c each combine the functions of crankshaft 11 and camshaft 91 from FIG. 3 and replace them. Their features, crank 10, eccentric 12, and cam 90, are machined into a single unitary steel part with mainshaft 11c and renamed as a crank 10c, an eccentric 12c and a cam 90c in FIG. 4, but the features themselves are not altered from the first embodiment. A mainshaft 11c is located at each opening of cylinder 30 with alternating iterations of crank 10c (with eccentric 12c) and cam 90c along its length to align with each respective cylinder 30. There is one crank 10c and one cam 90c for each cylinder 30. Each mainshaft 11 c is rotationally connected to a cast aluminum crankcase (not shown) in order to turn perpendicular the cylinder 30 bore (not labelled). Arrows (not labelled) indicate direction of rotation in FIG. 4. Mainshaft 11c has an end 15 and an end 16. Both ends, 15 and 16, are constructed to serve as a utility end 14 or an output end 13 (from FIG. 3 first embodiment), because mainshaft 11c is a single version part that operates on either side of cylinder 30 by orienting the ends 15 and 16. The cylinders 30 are numbered #1, #2, #3, and #4. A firing order of 1-3-4-2 will allow four cylinders 30 in a cylinder bank to use two copies of mainshaft 11c. Balancing and flywheel mass were omitted from mainshaft 11c for clarity, but they are known in the art. The other parts are in accordance with the first embodiment.

In FIG. 4, cam 90c must turn in the same direction as cam 90 does in FIG. 1A to maintain the force geometry of FIG. 1A. This second embodiment causes crank 10c to turn in the opposite direction as crank 10 in FIG. 1A. Consequently, eccentric 12c should be placed in the mirrored position of the first embodiment with respect to centerline 01 (FIG. 3) to cause the appropriate piston strokes due to the oppositely rotating mainshafts 11c. Otherwise, operation is similar the first embodiment.

### Third Embodiment

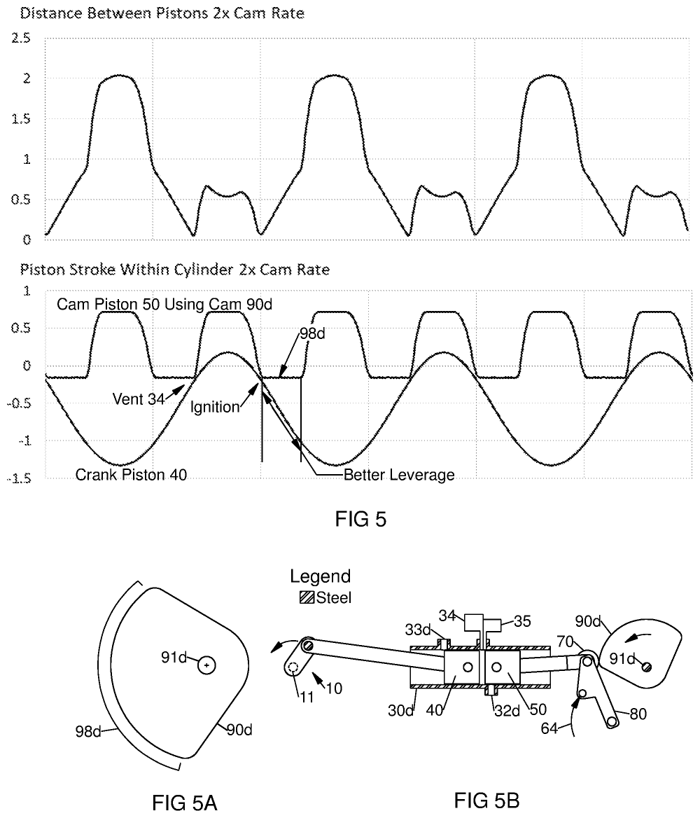

FIGS. 5, 5A, and 5B show that this engine can run as a combination of 2-stroke and 4-stroke pistons. The relevant alterations are described assuming a realization of the components in the first embodiment. In FIG. 5B, crankshaft 11 rotationally connects to a power transmission set (not shown) that has a gear ratio of 2:1. It turns a steel camshaft 91d twice for every single crankshaft 11 rotation. FIG. 5A illustrates a cam 90d that, along with crank 10, created the chart data in FIG. 5. Cam 90d is a cam lobe that is a machined feature of camshaft 91d. In FIG. 5A, cam 90d has a dwell 98d. FIG. 5B shows a vent 34 that is a solenoid controlled valve installed through a wall of a cylinder 30d near the combustion end of piston 50 at its dwell 98d position. Vent 34 is controlled by a timing system (not shown). A spark ignition system, ignition 35, is installed adjacent to vent 34 in cylinder 30d and is also controlled by the timing system (not shown). A fuel injection system, injector 32d, is installed where intake 32 was located in the first embodiment, FIG. 3. A forced induction system is installed through cylinder 30d adjacent to injector 32d (not shown). An exhaust 33d is the same as exhaust 33 FIG. 3. These features are known in the art of engine building.

In this embodiment, crank piston 40 functions in 2-strokes, while cam piston 50 functions in 4-strokes. Combustion is similar to the first embodiment, until the crank piston 40 begins its second stroke, which is its return toward cam piston 50, FIG. 5. The vent 34 manages the gas pressure between pistons 40 and 50 during the return stroke of piston 40. The vent 34 releases much of the gas from cylinder 30, so the forced induction will increase the compression density for the next combustion stroke. The rest of the embodiment operates as the first embodiment.

### Fourth Embodiment

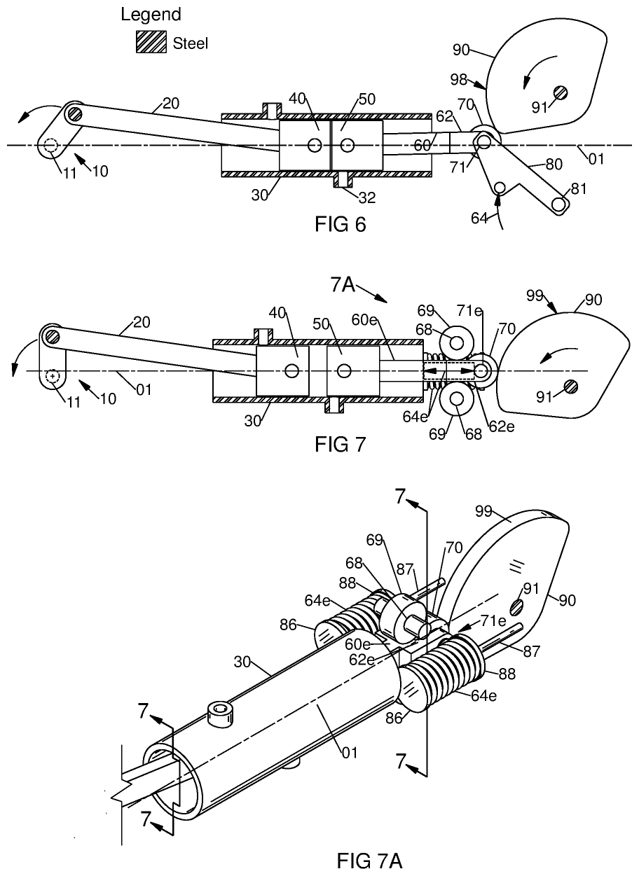

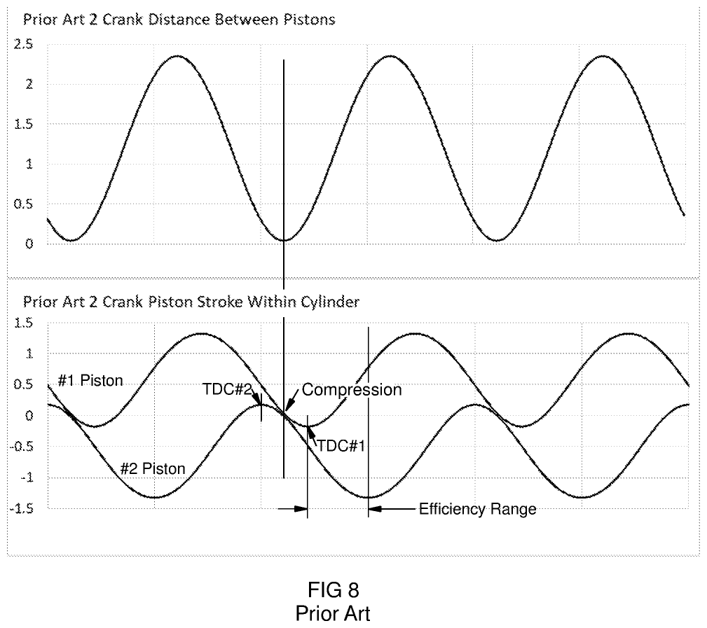

FIG. 6 shows another embodiment which is a re-arrangement of pin 71, pin 81, and camshaft 91 of the first embodiment. Only their relative placement is changed from the first embodiment which requires an adjustment to a cast aluminum crankcase (not shown). Camshaft 91 is located on an opposite side of centerline 01 as pin 81, while pin 81 is placed at a greater distance from cylinder 30. Pin 71 is consequently aligned with centerline 01 as dwell 98 occurs (from FIG. 2A). The power transmission set (not shown) is fitted appropriately to turn camshaft 91 at a 1:1 ratio with crankshaft 11. The rest of the construction is the same as the first embodiment.

It is believed that this arrangement will cause strut 80 and cam 90 to share the combustive force. It will also offer more leverage for compression, however the stroke of piston 50 is reduced which reduces compression density, but a forced induction system (not shown) used at intake 32 would increase compression density.

### Fifth Embodiment

FIG. 7 shows another embodiment that removes the strut 80 of FIG. 3 from the first embodiment. Again, realizing the components of the first embodiment and the power transmission of 1:1 ratio, an alimunum cam rod 60e is the same rod as rod 60 in FIG. 3, but 60e has an upper flat surface and a lower flat surface (not labelled). The flat surfaces are constructed to roll along two steel rod rollers 69 along the length of rod 60e travel. Rod rollers 69 are each rotationally connected to steel rod roller pins 68. Pins 68 are rigidly connected to a cast aluminum crankcase (not shown). Rod 60e has a bifurcated end 62e constructed to rigidly connect to a steel pin 71e. Roller 70 is the same as the first embodiment and is rotationally connected to pin 71e within a bifurcated gap in end 62e. In FIG. 7A, pin 71e is constructed to have a spring plate 88 at each end. Plate 88 is constructed to host a spring 64e and is slidably fitted to a linear guide 87 through its center. Guide 87 is a rigid feature of a spring plate 86. Spring plate 86 is constructed to host compression spring 64e and its spring force between itself and plate 88. There are two iterations of each spring 64e, plates 86 and 88, and guide 87 per cylinder that are parallel to the bifurcated end 62e. Spring pressure sufficiently maintains contact between roller 70 and surface 99 as cam 90 rotates. FIG. 7 shows camshaft 91 is located slightly below centerline 01 in this embodiment. Crankshaft 11 is also offset slightly from centerline 01 in a direction that reduces the angle between rod 20 and centerline 01 during its outward stroke while maintaining clearance between rod 20 and cylinder 30 throughout the rotation of crankshaft 11. Camshaft 91 and crankshaft 11 are rotational connections slightly lowered in the cast aluminum crankcase (not shown).

This embodiment causes rod 60e to move in a more linear fashion causing the springs to operate in a substantially linear direction by not using strut 80 of FIG. 3. Guides 87 each limit end 62e from rotating about centerline 01. The widths of cam 90 and roller 70 enhance alignment between rod 60e and centerline 01. The camshaft offset from centerline 01 is done for leverage between cam 90 and rod 60e, and the offset crankshaft 11 is an attempt to reduce friction between cylinder 30 and piston 40 during combustion force.

### CONCLUSION

The crank and cam piston actuation relationship is an advantage that puts crank leverage, compression, and ignition together. There are few engines that can do this. The engine functions that are options around this relationship are too numerous to eliminate experimentation, but the crank and cam relationship will bring a needed efficiency to opposed piston engines in general.

I claim:

1. An opposed piston combustion engine comprising:
a. a cylinder with a substantially uniform bore,
b. a crank that is rotationally supported relative to said cylinder,
c. a first piston actuated by said crank and slidably fit into said cylinder through a first open end of said cylinder,
d. a cam that is rotationally supported relative to said cylinder,
e. a second piston actuated by said cam and slidably fit into said cylinder through a second open end of said cylinder while facing said first piston,
f. a first means to rotationally couple said cam to said crank,
g. a second means to aspirate said cylinder with a combustive air and fuel mixture between said pistons,
h. a third means to aspirate said cylinder of exhaust gas, whereby said engine may produce a usable force.

2. The device of claim 1 wherein said cylinder is included in a crankcase which is structural support for said crank and said cam.

3. The device of claim 2 wherein said crankcase is cast aluminum.

4. The device of claim 2 wherein said pistons are each actuated through a rod.

5. The device of claim 2 wherein said cam and said crank are both fashioned onto a common mainshaft that is rotationally supported by said crankcase with multiple said cylinders in a bank with alternating iterations of said crank and said cam aligned to actuate said respective pistons within said cylinders.

6. A method of creating an opposed piston combustion engine comprising:
a. providing a cylinder with a uniform bore that concentrically and slidably hosts a first piston and a second piston,
b. supporting a rotation of a crank and a cam relative to said cylinder,
c. actuating said first piston by said crank,
d. actuating said second piston by said cam,
e. coupling rotation of said crank to said cam,
f. causing said cam actuated piston to encroach upon said crank actuated piston at a position that provides a desired leverage upon said crank during a combustive event,
g. aspirating said cylinder appropriate to maintain combustive events between said pistons to maintain rotation of said crank,
whereby said engine may produce a usable force.

7. The method of claim 6 with:
a. combining said crank and said cam onto a mainshaft,
b. orienting an appropriate alignment of alternating iterations of said crank and said cam on said mainshafts commensurate to multiple said cylinders,
c. actuating said pistons within multiple said cylinders, thereby creating a bank of cylinders each hosting separate pairs of said first and second pistons,
d. causing each said cam actuated piston to encroach upon each said respective crank actuated piston at a position that provides a desired leverage upon said respective crank during a respective combustive event.

8. The method of claim 7 with timing the combustive events within each said cylinder to occur at a determined time with respect to the other said cylinders.
